(19) United States
(12) Patent Application Publication
(10) Pub. No.: US 2008/0153656 A1
(43) Pub. Date: Jun. 26, 2008

(54) Torsional damping assembly

(75) Inventors: Karl A. Nerstad, East Peoria, IL (US); James E. Winzeler, East Peoria, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc.

(21) Appl. No.: 11/642,300

(22) Filed: Dec. 20, 2006

(51) Int. Cl. F16H 57/08

(52) U.S. Cl. 475/331; 475/346

(57) ABSTRACT

A torsional damping assembly is disclosed. The assembly includes an input member; a planetary gear assembly including a ring gear member, a carrier member, a sun gear member, and a torsional coupling; an output member and a stationary member. The input member is operably coupled to one of the planetary gear members. The torsional coupling in operably coupled to one of the planetary gear members and the stationary member. The output member is operably coupled to one of the planetary gear members.

### TECHNICAL FIELD

The invention relates generally to power transmitting devices and more particularly to torsional vibration damping between an input member and a coaxial output member in a work machine power train.

### BACKGROUND

A torsional coupling is generally interposed between a driving shaft or input member and a coaxial driven shaft or output member. This type of device is to permit regulated transmission of rotational power between the members while filtering out vibrations, which may occur in the system, such as in a power train between a vehicle engine and a generator or transmission acting to drive the wheels of the vehicle. Engine torsionals if not damped could damage the generator and increase wear over time.

A conventional torsional coupling or damper generally comprises circumferentially acting resilient means, such as helical springs, which are positioned in axially aligned spring windows formed in two or more plates capable of relative rotation there between. When power is applied to the driving plates, the springs are compressed to resiliently urge rotation of the driven plate. A helical spring damper is typically used in a vehicle friction clutch or a lock-up clutch within a torque converter housing to dampen the impulses of the vehicle engine, which would otherwise cause undesirable characteristics; e.g. impact loads, pulsations, noises, etc. in the power train of the vehicle. An example of a helical spring torsional coupling is found in U.S. Pat. No. 5,784,929 issued to Abraham, et al.

Other types of torsional couplings include spiral disc couplings an example of which is described in U.S. Pat. No. 4,795,012 issued to Durum; and rubber or flexible material torsional couplings such as the one described in U.S. Pat. No. 3,727,431 issued to Yokel.

The torsional couplings are subject to wear because of the torsional vibrations they damp. In addition to torsional stresses, the torsional couplings are also subject to centrifugal forces as they rotate with the input and output members. For example, in helical spring torsional couplings, the springs are subject to frictional forces not only on the ends from damping forces, but also on the sides due to centrifugal forces. This can cause shortened service intervals, decreased life, and increased downtime for a machine utilizing them. Oil has been introduced into the spring recess and this has reduced wear. However, costs increased. Eliminating the centrifugal forces on a torsional coupling would increase their life, lengthen service intervals and decrease downtime.

The present disclosure is directed to overcome one or more of the problems as set forth above.

### SUMMARY OF THE INVENTION

In one aspect of the present invention a torsional damping assembly is disclosed. The torsional damping assembly includes a planetary gear assembly that includes a ring gear member, a carrier member, a planet gear and a sun gear member. An input member is operably coupled to one of the ring gear member, the carrier member and the sun gear member. A torsional coupling is operably coupled to one of the ring gear member, the carrier member and the sun gear member; and to a stationary member. An output member is operably coupled to one of the ring gear member, the carrier member and the sun gear member.

In another aspect of the present invention a work machine power train is disclosed. The work machine power train includes a planetary gear assembly including a ring gear member, a carrier member and a sun gear member. A prime mover is operably coupled through an input member to one of the ring gear member, the carrier member and the sun gear member. A load is operably coupled through an output member to one of the ring gear member, the carrier member and the sun gear member. A torsional coupling is operably coupled to one of the ring gear member, the carrier member and the sun gear member; and a stationary member.

### BRIEF DESCRIPTION OF THE DRAWINGS

FIG. 1 is a side view of a first exemplary embodiment of a work machine;

FIG. 2 is a sectional view of a first exemplary embodiment of a planetary gear assembly;

FIG. 3 is a sectional view of a second exemplary embodiment of a planetary gear assembly;

FIG. 4a is a diagram of a third exemplary embodiment of a planetary gear assembly;

FIG. 4b is a diagram of a fourth exemplary embodiment of a planetary gear assembly;

FIG. 5 is a diagram of a fifth exemplary embodiment of a planetary gear assembly;

FIG. 6 is a diagram of a sixth exemplary embodiment of a planetary gear assembly;

FIG. 7 is a diagram of a seventh exemplary embodiment of a planetary gear assembly;

FIG. 8a is a sectional view of an exemplary embodiment of a torsional coupling; and

FIG. 8b is a plane view of an exemplary embodiment of a torsional coupling.

### DETAILED DESCRIPTION

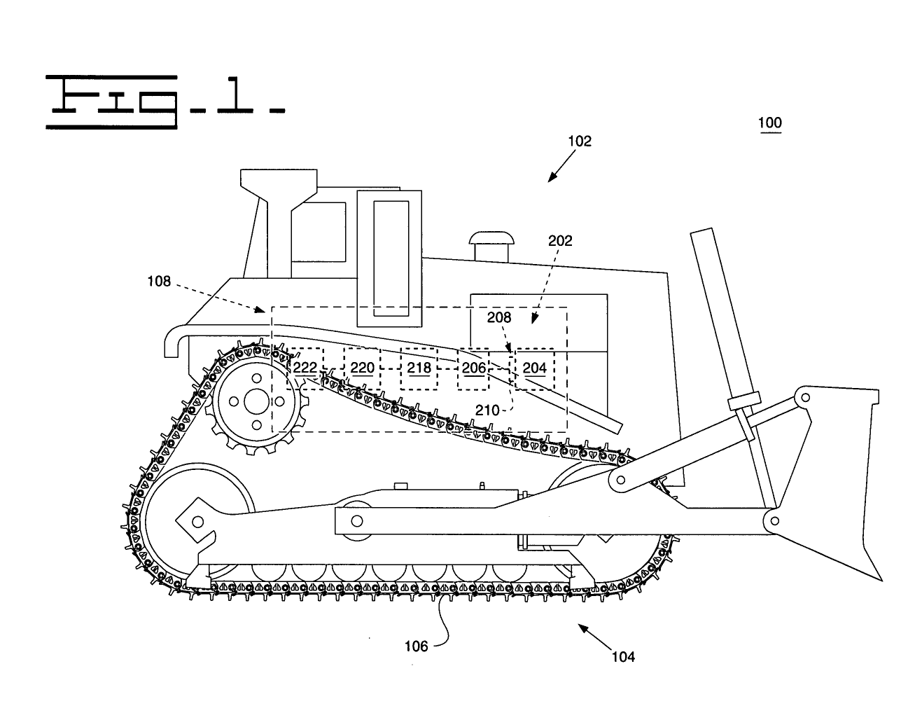

Referring now to the drawings FIG. 1 depicts a vehicle 100, which is shown for example as being a track type bulldozer 102. Although a track type bulldozer 102 is described herein, the invention encompasses other mobile or stationary equipment such as generator sets, wheel loaders, backhoe loaders, excavators, off-highway mining trucks, on-highway trucks and other equipment.

The vehicle 100 includes a pair of ground engaging devices 104 (only one shown in FIG. 1) that are powered by a power train 108. The ground-engaging device 104, shown in FIG. 1, is an endless track chain 106. In other embodiments the ground engaging devices 104 may be wheels, belts, walking beams or any other known ground engaging devices 104.

The vehicle 100 includes a power train 108, which powers the ground engaging devices 104 to provide motive power to the vehicle 100. Still referring to FIG. 1, the power train 108 may include a prime mover 202, a planetary gear assembly 206, a generator or transmission 218, power electronics 220 and motors 222.

The prime mover 202 may be an internal combustion engine 204. It may also be a rotary engine, a hydraulic pump or any other prime mover, which translates rotational power to another member as would be known to those skilled in the art. The engine 204 may include an input member 208 such as a flywheel 210. The input member 208 transmits power from the prime mover 202 to the planetary gear assembly 206. The engine 204 may be operably coupled to a planetary gear assembly 206 in a manner that transmits power from the engine 204 to the planetary gear assembly 206 through the flywheel 210.

The planetary gear assembly 206 may be operably coupled to a generator 218. The generator 218 may be operably coupled to power electronics 220. The power electronics 220 may be operably coupled to motors 222. The motors 222 may be operably coupled to the ground engaging devices 104 in such a manner as to move the vehicle 100.

In alternative embodiments, the planetary gear assembly 206 may be coupled to power train 108 components other than the generator 218. For example the planetary gear assembly 206 may be operably connected between a hydraulic pump, a torque converter, or other power train 108 components that would be known to one skilled in the art.

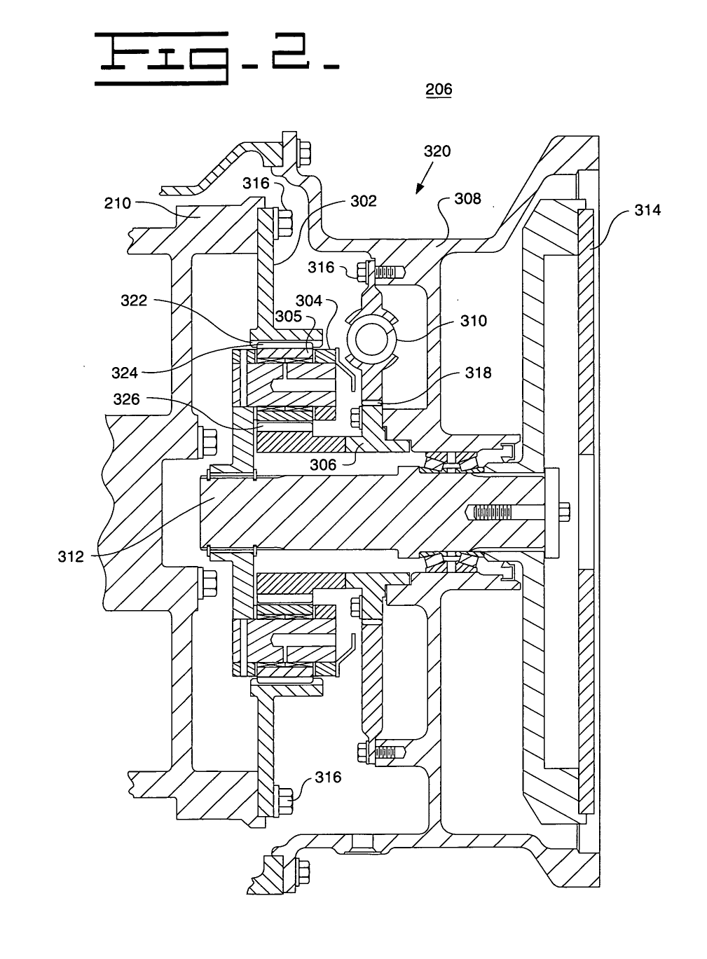

Referring now to FIG. 2, a sectional view of an exemplary first embodiment of the planetary gear assembly 206 is shown. The engine flywheel 210 transmits power to and through the planetary gear assembly 206.

The planetary gear assembly 206 includes a ring gear member 302, a carrier member 304, at least one planet gear member 305 (typically two or more planet gear members 305), a sun gear member 306, a casing 308, a torsional coupling 310, a shaft 312, and an output member 314. As in any planetary gear assembly 206 the planetary gear member 305 rotates around and meshingly engages the sun gear member 306 with the carrier member connecting and holding the planetary gear members 305 together in a circumferentially spaced relationship around the sun gear member 306. The ring gear member 302 meshingly engages and is positioned about the planetary gear members 305.

The flywheel 210 may be operably coupled to the ring gear member 302 by bolts 316. The torsional coupling 310 may be operably coupled to the casing 308 by bolts 316. In alternative embodiments the torsional coupling may be operably coupled to any stationary member 320 on the vehicle 100 or in the environment in place of the casing 308. For example, the torsional coupling 310 may be operably coupled to the frame of the vehicle 100. On a stationary machine 100 in a factory, the torsional coupling 310 may be operably coupled to the factory floor or a factory pillar.

The torsional coupling 310 may be operably coupled to the sun gear member 306 by splines 318 in such a way as to prevent the sun gear member 306 from rotating more than a few degrees. In an alternative embodiment the torsional coupling 310 may be an integral part of the sun gear member 306. The carrier member 304 may be operably coupled to the shaft 312 by for example splines, keyed or by other means. The shaft 312 may be operably coupled to an output member 314 by for example splines, keyed or by other means. The output member 314 may then be operably coupled to the generator 218 by for example bolts 316 (not shown in FIG. 2).

The flywheel 210 may transmit power to the ring gear member 302. The ring gear member 302 engages the planet gear member 305 via a plurality of ring gear teeth 322 and a plurality of planet gear teeth 324. Because the sun gear member 306 is prevented from rotating by the torsional coupling 310, the rotational power of the ring gear member 302 may be transmitted to the carrier member 304. The planet gear teeth 324 may engage the sun gear teeth 326 and because the sun gear member 306 may be operably coupled to the torsional coupling 310, the engine 204 torsionals may be transmitted through the sun gear 306 and damped by the torsional coupling 310. The carrier member 304 may transmit power to the shaft 312. The shaft 312 may transmit power to the output member 314 which may transmit power to the generator 218 (not shown).

In this first embodiment of the planetary gear assembly 206 the engine 204 may rotate at a higher speed than the generator 218.

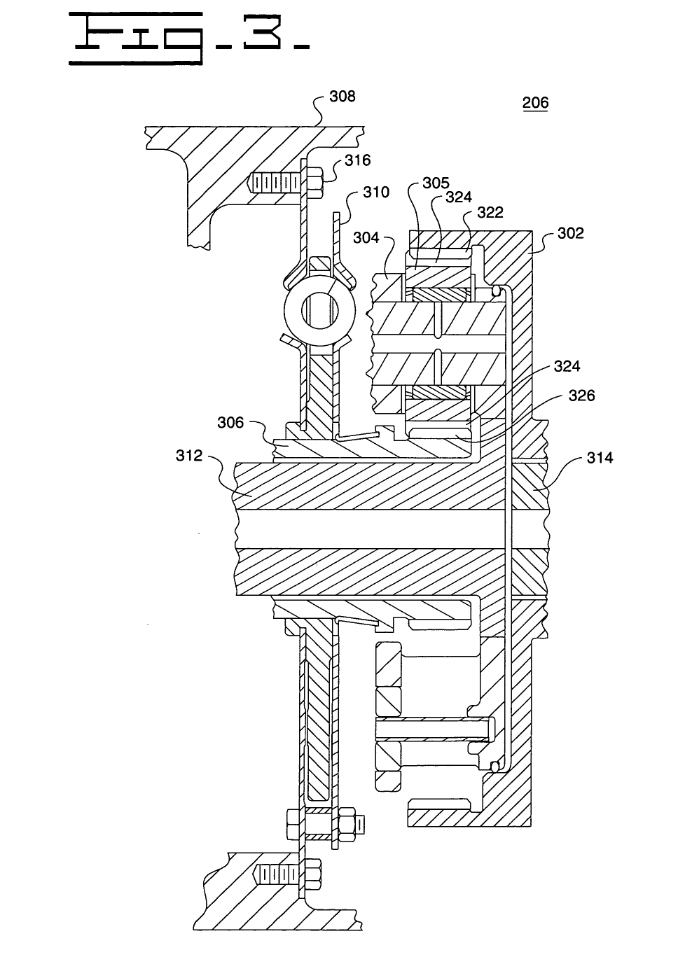

FIG. 3 depicts a second embodiment of the planetary gear assembly 206 where the planetary gear assembly 206 the engine 204 may rotate at a lower speed than the generator 218.The flywheel 210 may be operably coupled to a shaft 312. The shaft may be operably coupled to the carrier member 304 by for example splines. In an alternative embodiment the carrier member 304 may be an integral part of the shaft 312 or the carrier member 304 and shaft 312 may be operably coupled in any method that may be known by those skilled in the art. The sun gear member 306 may be coupled to the torsional coupling 310 by for example splines. The torsional coupling 310 may be operably coupled to the casing 308 by for example bolts 316 in such a way as to prevent the sun gear member 306 from rotating. The ring gear member 302 may be operably coupled to the output member 314. The output member 314 may then be operably coupled to the generator 218 (not shown).

The flywheel 210 may transmit power through the shaft 312 to the carrier member 304. The planet gear teeth 324 may engage the ring gear teeth 322. Because the sun gear member 306 is prevented from rotating by the torsional coupling 310, the rotation power of the carrier member 304 may be transmitted to the ring gear member 302. The planet gear teeth 324 may engage the sun gear teeth 326 and because the sun gear member 306 may be operably coupled to the torsional coupling 310, the engine 204 torsionals may be transmitted through the sun gear 306 and damped by the torsional coupling 310. The ring gear member 302 may transmit power to the output member 314 which may transmit power to the generator 218.

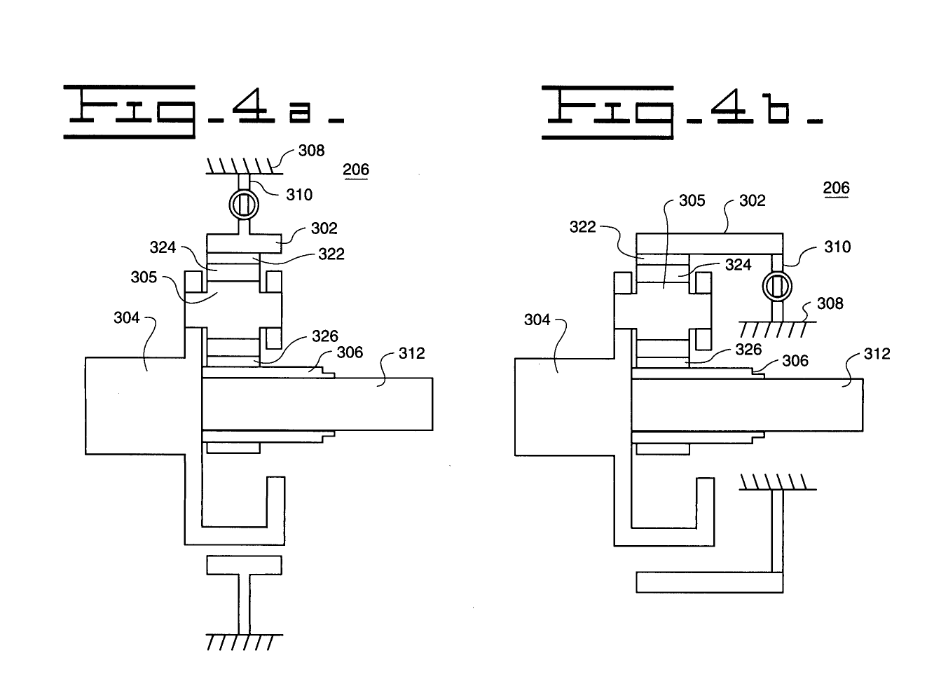

FIG. 4a depicts a third embodiment of the planetary gear assembly 206, wherein the engine 204 may rotate at a higher speed than the generator 218. The flywheel 210 (not shown in FIG. 4a) may be operably coupled to the carrier member 304. The ring gear member 302 may be coupled to the torsional coupling 310 by for example bolts 316 as seen in FIG. 3, splines or any other method known by those who are skilled in the art. In one embodiment the torsional coupling 310 may be an integral part of the ring gear member 302. The torsional coupling 310 may be operably coupled to the ring gear member 302 on the outside of the ring gear member 302. The torsional coupling 310 may be operably coupled to the casing 308 in such a way as to prevent the ring gear member 302 from rotating more than a few degrees. The sun gear member 306 may be operably coupled to the shaft 312 by for example splines. The shaft 312 may be operably coupled to the output member 314 (shown in FIG. 4a). The output member 314 may be operably coupled to the generator 218 (not shown).

The flywheel 210 may transmit power to the carrier member 304. The planet gear teeth 324 may engage the sun gear teeth 326. Because the ring gear member 302 is prevented from rotating by the torsional coupling 310, the rotational power of the carrier member 304 may be transmitted to the sun gear member 306. The planet gear teeth 324 may engage the ring gear teeth 322 and because the ring gear member 302 may be operably coupled to the torsional coupling 310, the engine 204 torsionals may be transmitted through the ring gear 302 and damped by the torsional coupling 310. The sun gear member 306 may transmit power to the shaft 312 which may transmit power to the output member 314. The output member 314 may transmit power to the generator 218.

FIG. 4b depicts a fourth embodiment of the planetary gear assembly 206, wherein the engine 204 may rotate at a higher speed than the generator 218. The flywheel 210 may be operably coupled to the carrier member 304. The ring gear member 302 may be coupled to the torsional coupling 310 by for example bolts 316, splines or any other method known by those who are skilled in the art. In one embodiment the torsional coupling 310 may be an integral part of the ring gear member 302. The torsional coupling 310 may be operably coupled to the ring gear member 302 on the inside of the ring gear member 302. The torsional coupling 310 may be operably coupled to the casing 308 in such a way as to prevent the ring gear member 302 from rotating. The sun gear member 306 may be operably coupled to the shaft 312 by for example splines. The shaft 312 may be operably coupled to the output member 314 (not shown in FIG. 4b). The output member 314 may be operably coupled to the generator 218.

The flywheel 210 may transmit power to the carrier member 304. The planet gear teeth 324 may engage the sun gear teeth 326. Because the ring gear member 302 is prevented from rotating by the torsional coupling 310, the rotational power of the carrier member 304 may be transmitted to the sun gear member 306. The planet gear teeth 324 may engage the ring gear teeth 322 and because the ring gear member 302 may be operably coupled to the torsional coupling 310, the engine 204 torsionals may be transmitted through the ring gear 302 and damped by the torsional coupling 310. The sun gear member 306 may transmit power to the shaft 312 which may transmit power to the output member 314. The output member 314 may transmit power to the generator 218.

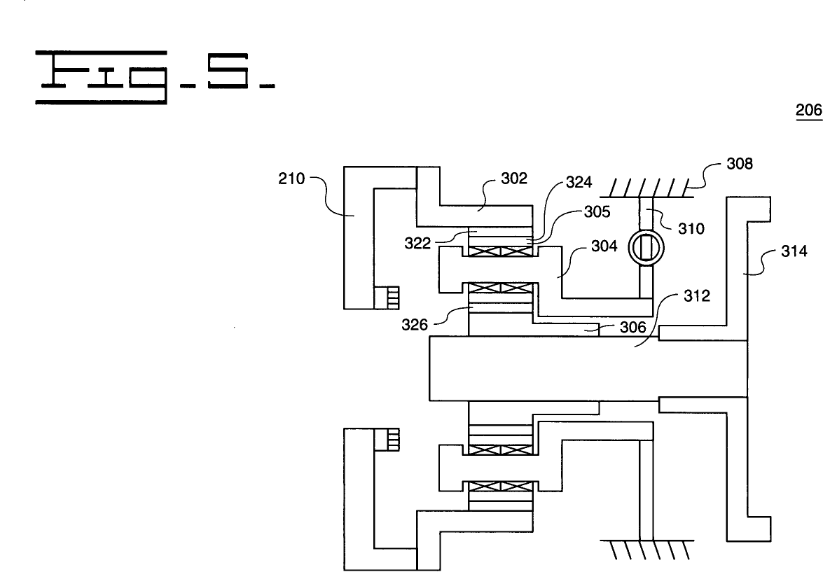

FIG. 5 depicts a fifth embodiment of the planetary gear assembly 206 wherein the engine 204 may rotate at a lower speed than the generator 218 and in the opposite direction. The flywheel 210 may be operably coupled to the ring gear 302 by for example bolts 316 (shown if FIG. 2). The carrier member 304 may be coupled to the torsional coupling 310 by for example bolts 316 (not shown in FIG. 5), splines or any other method known by those who are skilled in the art. The torsional coupling 310 may be operably coupled to the casing 308 in such a way as to prevent the carrier member 304 from rotating. The sun gear member 306 may be operably coupled to the shaft 312 by for example splines. The shaft may be operably coupled to the output member 314. The output member 314 may be operably coupled to the generator 218.

The flywheel 210 may transmit power to the ring gear member 302. The ring gear teeth 322 may engage the planet gear teeth 324 which may engage the sun gear teeth 326. Because the carrier member 304 is prevented from rotating by the torsional coupling 310, the rotational power of the ring gear member 302 may be transmitted to the sun gear member 306. Because the carrier member 304 may be operably coupled to the torsional coupling 310, the engine 204 torsionals may be transmitted through the ring gear 302 to the carrier member 304 and then damped by the torsional coupling 310. The sun gear member 306 may transmit power to the shaft 312 which may transmit power to the output member 314. The output member 314 may transmit power to the generator 218.

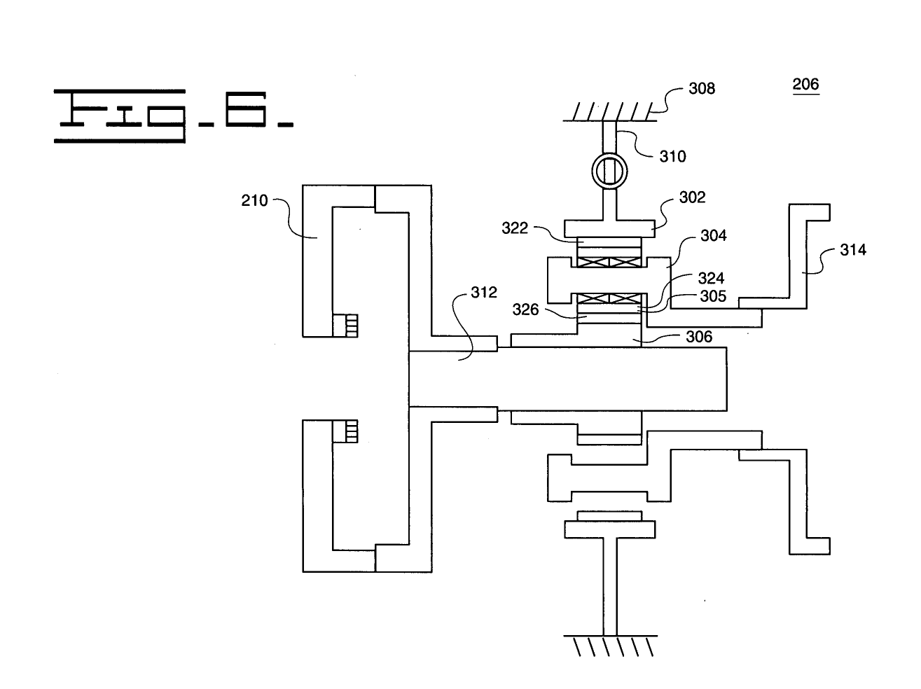

FIG. 6 depicts a sixth embodiment of the planetary gear assembly 206 wherein the engine 204 may rotate at a lower speed than the generator 218 and in the opposite direction. The flywheel 210 may be operably coupled to a shaft 312. The shaft 312 may be operably coupled to the sun gear 306 by for example splines or any other method that may be known by those skilled in the art. The ring gear member 302 may be coupled to the torsional coupling 310 by for example bolts 316 (not shown) or in an alternative embodiment splines. The torsional coupling 310 may be operably coupled to the casing 308 in such a way as to prevent the ring gear member 302 from rotating. The carrier member 304 may be operably coupled to the output member 314. The output member 314 may be operably coupled to the generator 218.

The flywheel 210 may transmit power through the shaft 312 to the sun gear member 306. The sun gear teeth 326 may engage the planet gear teeth 324. Because the ring gear member 302 is prevented from rotating by the torsional coupling 310, the rotational power of the sun gear member 306 may be transmitted to the carrier member 304. The planet gear teeth 324 may engage the ring gear teeth 322 and because the ring gear member 302 may be operably coupled to the torsional coupling 310, the engine 204 torsionals may be transmitted through the sun gear 306 and carrier member 304 to the ring gear member 302 and then damped by the torsional coupling 310. The carrier member 304 may transmit power to the output member 314 which may transmit power to the generator 218.

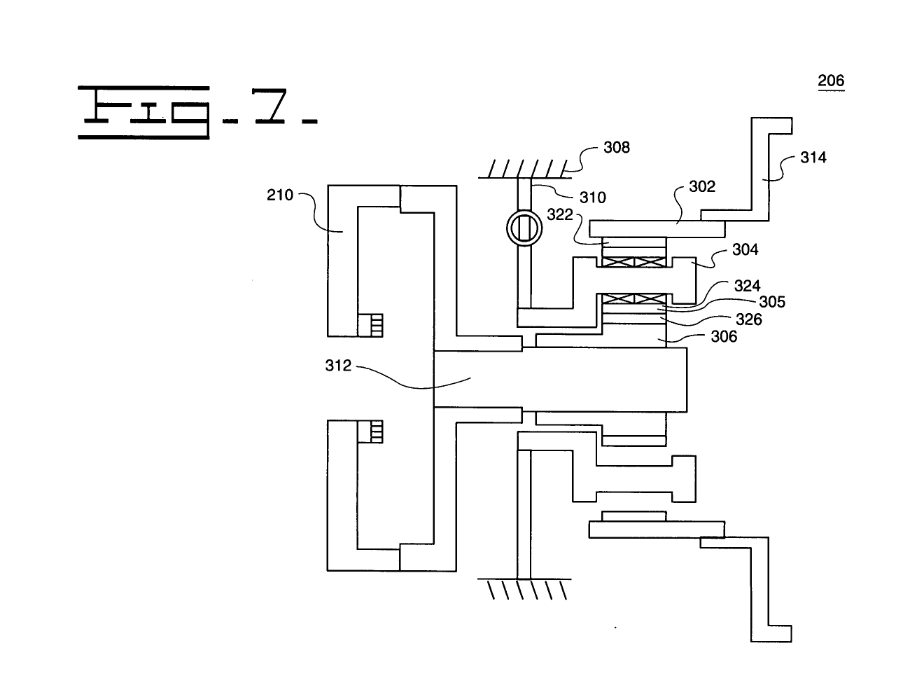

FIG. 7 depicts a seventh embodiment of the planetary gear assembly 206 wherein the engine 204 may rotate at a lower speed than the generator 218 and in the opposite direction. The flywheel 210 may be operably coupled to a shaft 312. The shaft 312 may be operably coupled to the sun gear 306 by for example splines or any other method that may be known by those skilled in the art. The carrier member 304 may be operably coupled to the torsional coupling 310 by for example bolts 316 (not shown in FIG. 7) or in an alternative embodiment splines. In one embodiment the torsional coupling 310 may be an integral part of the carrier member 304. The torsional coupling 310 may be operably coupled to the casing 308 in such a way as to prevent the carrier member 304 from rotating. The ring gear member 302 may be operably coupled to the output member 314. The output member 314 may be operably coupled to the generator 218 (not shown).

The flywheel 210 may transmit power through the shaft 312 to the sun gear member 306. The sun gear teeth 326 may engage the planet gear teeth 324 which may engage the ring gear teeth 322. Because the carrier member 304 is prevented from rotating by the torsional coupling 310, the rotational power of the sun gear member 306 may be transmitted to the ring gear member 302. Because the carrier member 304 may be operably coupled to the torsional coupling 310, the engine 204 torsionals may be transmitted through the sun gear member 306 to the carrier member 304 and then damped by the torsional coupling 310. The ring gear member 302 may transmit power to the output member 314 which may transmit power to the generator 218.

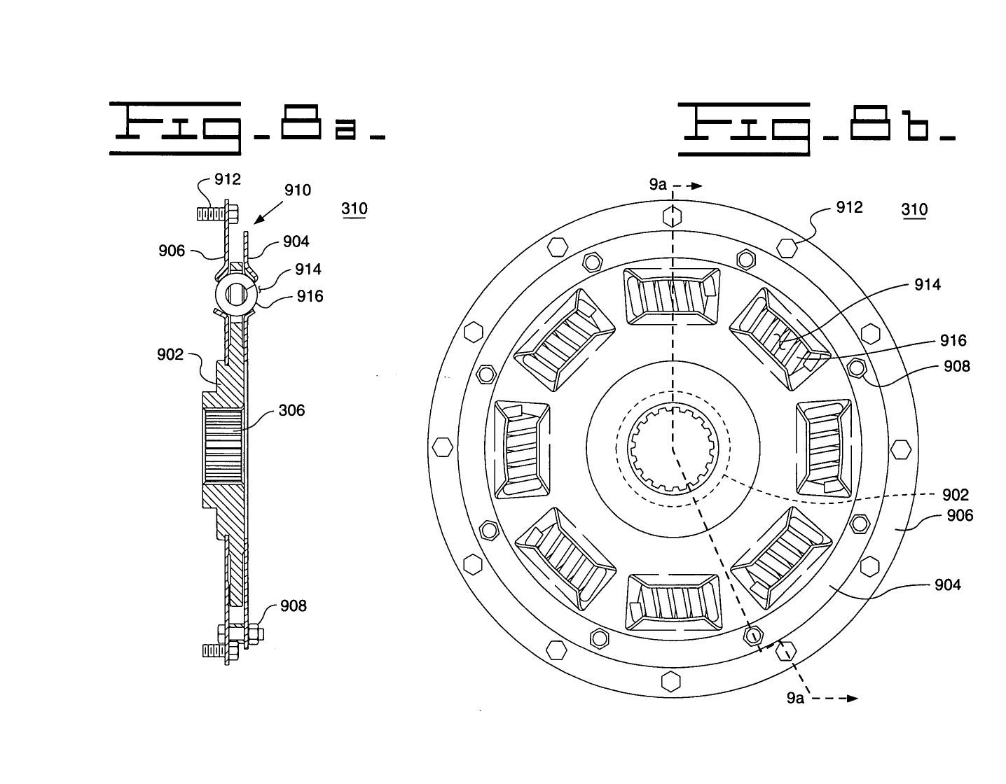

FIGS. 8a and 8b depict an exemplary helical spring torsional coupling 310 suitable for use in the embodiments shown in FIGS. 3-8. Helical spring torsional couplings are well known in the art and many embodiments would be suitable for use as would be realized by one skilled in the art. Other embodiments encompassed by the invention include flexible material torsional couplings 310, shock absorber torsional couplings 310 or other torsional couplings 310 that are known to those skilled in the art.

Referring to FIG. 8a, which is a section view of FIG. 8b, an inner periphery of an annular output hub 902 is splined to a planetary gear assembly 206 member. For example, it may be splined to a sun gear member 306 as depicted in FIG. 3. In alternative embodiments the hub 902 may be bolted or keyed to the planetary gear assembly 206 member. In still other embodiments the hub 902 may be an integral part of a planetary gear assembly 206 member.

A first plate 904 is coupled to a second plate 906 by plate bolts 908 to form cover assembly 910. Cover assembly 910 is operably coupled to a stationary member 320 (not shown) by bolts 912. For example, the cover assembly 910 may be bolted to the casing 308 as depicted in FIG. 2.

Referring to FIG. 8b, the hub, the first plate 904, and the second plate 906 are provided with openings 914 circumferentially equally spaced. In the embodiment depicted eight openings 914 are shown. In alternative embodiments there may be more or less openings as would be known by those skilled in the art. Compressible coil springs 916 are compressed in the openings 914 in such a way that the springs prevent the annular hub 902 from rotating, but allowing the compression and decompression of the springs 916 to absorb the engine 204 torsionals.

Other embodiments of the planetary gear assembly 306 may be used other than depicted in the FIGS. as will be recognized by one skilled in the art.

### INDUSTRIAL APPLICABILITY

Torsionals created by an internal combustion engine 204 or other prime mover 202 may damage other parts of the power train 108 if they are not damped. Traditional torsional dampers 310 positioned rotatably between two power train 108 members can suffer wear from centrifugal forces.

A planetary gear assembly 206 may be located between two power train 108 members on a vehicle 100. The vehicle 100 may be a tracked bulldozer 102 or it may be a stationary machine such as a generator set or a frac rig.

The planetary gear assembly 206 may include, a ring gear member 302, a carrier member 304, a planet gear member 305 and a sun gear member 306. One of the these members may be operably coupled to a torsional coupling 310 and the torsional coupling 310 may be operably coupled to a stationary member 320 in such a way as to prevent the one of the members from rotating.

Torsionals transmitted through the input member 208 may be damped by the torsional coupling 310. The planetary gear assembly 206 may reduce or increase rotational speed from one power train 108 member to another.

Because the torsional coupling 310 is stationary, it is not subject to wear due to centrifugal forces.

What is claimed is:

1. A torsional dampening assembly including;
a planetary gear assembly including a ring gear member, a carrier member, a planet gear member and a sun gear member,
an input member operably coupled to one of the ring gear member, the carrier member and the sun gear member,
an output member operably coupled to one of the ring gear member, the carrier member and the sun gear member,
a torsional coupling operably coupled to one of the ring gear member, the carrier member and the sun gear member, and operably coupled to a stationary member.

2. The assembly of claim 1, wherein the input member is operably coupled to the carrier member, the torsional coupling is operably coupled to the ring gear member, and the output member is operably coupled to the sun gear member.

3. The assembly of claim 1, wherein the input member is operably coupled to the carrier member, the torsional coupling is operably coupled to the sun gear member, and the output member is operably coupled to the ring gear member.

4. The assembly of claim 1, wherein the input member is operably coupled to the ring gear member, the torsional coupling is operably coupled to the carrier member, and the output member is operably coupled to the sun gear member.

5. The assembly of claim 1, wherein the input member is operably coupled to the ring gear member, the torsional coupling is operably coupled to the sun gear member, and the output member is operably coupled to the carrier member.

6. The assembly of claim 1, wherein the input member is operably coupled to the sun gear member, the torsional coupling is operably coupled to the ring gear member, and the output member is operably coupled to the carrier member.

7. The assembly of claim 1, wherein the input member is operably coupled to the sun gear member, the torsional coupling is operably coupled to the carrier member, and the output member is operably coupled to the ring gear member.

8. The assembly of claim 1, wherein the torsional coupling is operably coupled to the casing.

9. The assembly of claim 1, wherein the torsional coupling is operably coupled to a work machine frame.

10. The assembly of claim 1, wherein the torsional coupling is a helical spring torsional coupling.

11. The assembly of claim 1, wherein the torsional coupling is a shock absorber torsional coupling.

12. The assembly of claim 1, wherein the torsional coupling is a flexible material torsional coupling.

13. A work machine power train including;
a planetary gear assembly including a ring gear member, a carrier member and a sun gear member,
a prime mover operably coupled through an input member to one of the ring gear member, the carrier member and the sun gear member,
a load operably coupled through an output member to one of the ring gear member, the carrier member and the sun gear member,
a torsional coupling operably coupled to one of the ring gear member, the carrier member and the sun gear member, and operably coupled to a stationary member.

14. The power train of claim 13, wherein the prime mover is operably coupled to the carrier member, the torsional coupling is operably coupled to the ring gear member, and the load is operably coupled to the sun gear member.

15. The power train of claim 13, wherein the prime mover is operably coupled to the carrier member, the torsional coupling is operably coupled to the sun gear member, and the load is operably coupled to the ring gear member.

16. The power train of claim 13, wherein the prime mover is operably coupled to the ring gear member, the torsional coupling is operably coupled to the carrier member, and the load is operably coupled to the sun gear member.

17. The power train of claim 13, wherein the prime mover is operably coupled to the ring gear member, the torsional coupling is operably coupled to the sun gear member, and the load is operably coupled to the carrier member.

18. The power train of claim 13, wherein the prime mover is operably coupled to the sun gear member, the torsional coupling is operably coupled to the ring gear member, and the load is operably coupled to the carrier member.

19. The power train of claim 13, wherein the prime mover is operably coupled to the sun gear member, the torsional coupling is operably coupled to the carrier member, and the load is operably coupled to the ring gear member.
